(19) United States
(12) Patent Application Publication
(10) Pub. No.: US 2024/0349951 A1
(43) Pub. Date: Oct. 24, 2024

(54) COOKWARE WITH INSULATED HANDLE

(71) Applicant: E. MISHAN & SONS, INC., New York, NY (US)

(72) Inventor: Steven MISHAN, New York, NY (US)

(21) Appl. No.: 18/632,881

(22) Filed: Apr. 11, 2024

Related U.S. Application Data
(60) Provisional application No. 63/460,470, filed on Apr. 19, 2023.

(51) Int. Cl. A47J 45/08; A47J 45/06

(52) U.S. Cl. CPC A47J 45/08; A47J 45/061

(57) ABSTRACT

An article of cookware has a cooking body. A mounting part is coupled to the cooking body and includes a threaded aperture or a threaded stud. An insulator is coupled to the mounting part and has an aperture for allowing the threaded fastener or threaded stud to pass therethrough. A handle is coupled to the plastic insulator and has an aperture for allowing the threaded fastener or threaded stud to pass therethrough. The handle is fixedly secured to the mounting part, with the plastic insulator fixedly held between the handle and the mounting part, by securing the threaded fastener to the threaded aperture through the apertures on the plastic insulator and the handle or when the threaded nut is secured to the threaded stud, which passes through the apertures on the plastic insulator and the handle. The insulator reduces the conduction of heat into the handle.

### FIELD

This disclosure relates generally to a cookware with an insulated handle, and more particularly relates to a handle assembly for cookware which includes an insulator to reduce the heat transmitted from the cooking surface of the cookware into the handle.

### BACKGROUND

Pots, pans, and other types of cookware models are currently available which include a variety of different types of handles. When the handles are provided as metal or coated metal (the coating intended to provide insulation from heat), it can be difficult to grip the handle to lift or otherwise move the cookware during or after heating on a stove because the main body of the cookware is typically heated to a level that would not be safe for someone person to touch. Because a metal handle, coated or not, is such a good heat conductor, there is a need for a way to reduce the ability of a metal or coated metal handle to receive conducted heat from the heated surface of the cookware.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a top view of an article of cookware including a handle with an integrated insulator according to the present disclosure;

FIG. 2 is a first side view of the article of cookware shown in FIG. 1;

FIG. 3 is a second ide view of the article of cookware shown in FIG. 1;

FIG. 4 is a bottom view of the article of cookware shown in FIG. 1; and

FIG. 5A is a perspective view of the insulator included in the article of cookware shown in FIG. 1, and FIG. 5B is a side view thereof.

### DETAILED DESCRIPTION

In the present disclosure, like reference numbers refer to like elements throughout the drawings, which illustrate various exemplary embodiments of the present disclosure.

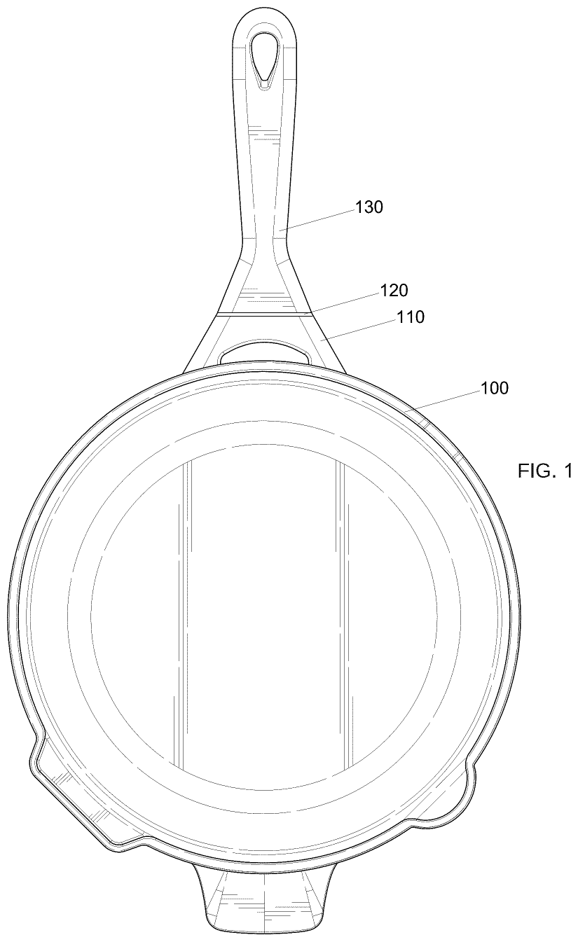

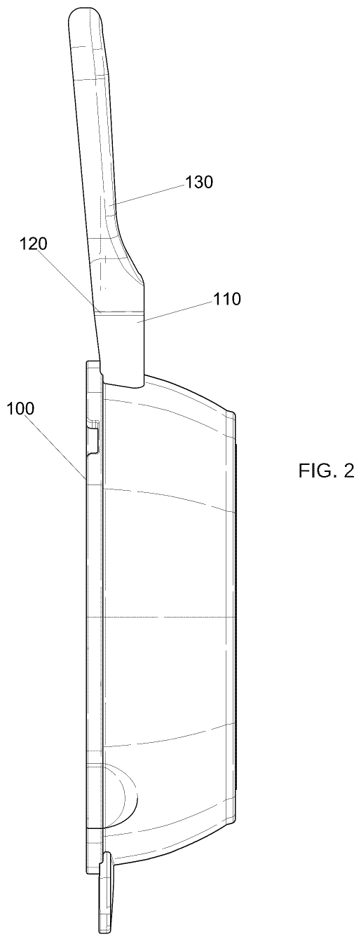

Referring now to FIGS. 1 to 4, an article of cookware is shown which includes a cooking body 100, a mounting part 110 that is affixed to the cooking body 100, an insulator 120, and a handle 130. The cooking body 100 and the mounting part 110 are formed from a metal such as aluminum. The mounting part 110 may be permanently affixed to the cooking body 100 or may be affixed via fasteners. The handle 130 may also be formed from a metal, such as aluminum, and may be coated with a non-metallic coating which also may assist in reducing heat conduction. It is to be noted that the handle 130 may be formed from other materials as well.

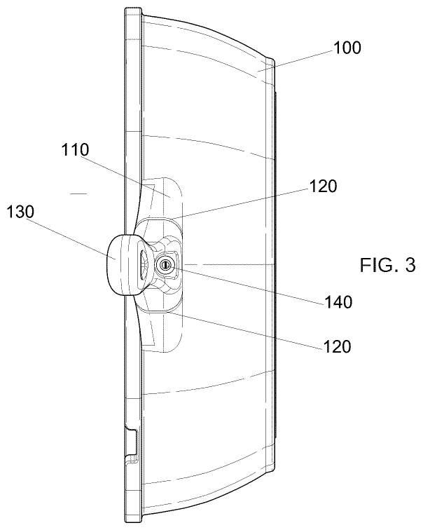

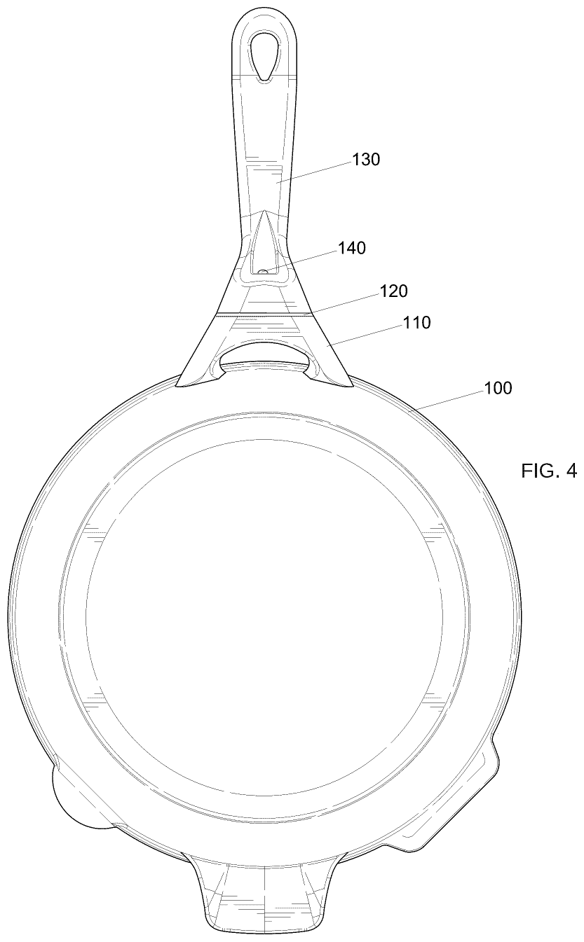

The mounting part 110 includes a threaded aperture for receiving a fastener, such as the fastener 140 (a screw) shown in FIGS. 3 and 4, for fixedly securing the insulator 120 and handle 130 to the cooking body 100. Other types of fasteners may be alternatively used that mate with threaded apertures, e.g., a bolt. As an alternative, a threaded stud may extend from mounting part 110 and a nut can be used to fixedly secure the insulator 120 and the handle 130 to the cooking body 100.

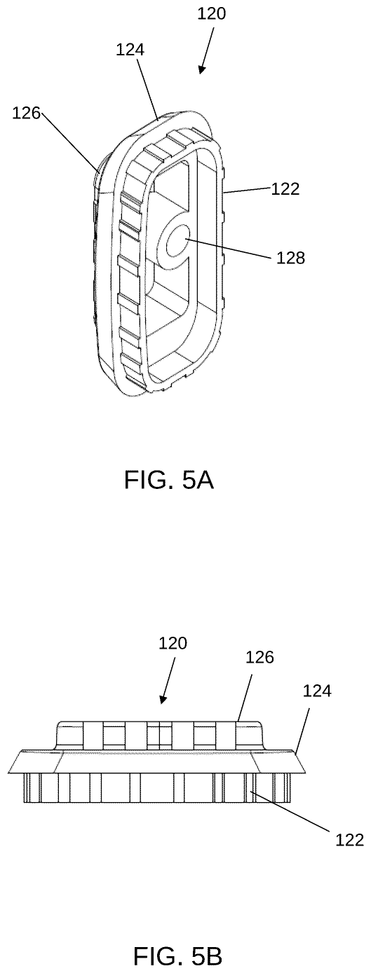

As shown in FIGS. 5A and 5B, the insulator 120 is configured to fit between an inner end of the handle 130 and the mounting part 110. The insulator 120 includes an inner collar 122, a middle portion 124, an outer collar 126, and an aperture 128. The inner collar 122 extends into an inner portion of the mounting part 110 and the outer collar 126 extends into an inner portion of the inner end of the handle 130. The middle portion 124 provides spacing between the mounting part 110 and handle 130 and, because of the heat resistant nature of the plastic material, provides much improved insulation to the handle 130, greatly reducing the transfer of heat from the cooking body 100 via the mounting part 110. The insulator 120 is held in place by fastener 140, which passes through an aperture at the inner end of handle 130, aperture 128 in the insulator 120, and into the threaded aperture in the mounting part 110.

The addition of insulator 120 helps to keep the overall handle temperature on handle 130 low enough so that a person can grip the handle 130 and move, lift, or shake the cookware article using the handle 130 without any type of hand protection, during and after the cooking process. The insulator 120 is preferably formed from a high heat resistant plastic material with good insulation properties, e.g., a thermoplastic polymer such as polymethylpentene. In other embodiments, other types of materials may be used, e.g., a rubber compound.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. An article of cookware, comprising:
a cooking body;
a mounting part coupled to the cooking body and including a threaded aperture for receiving a threaded fastener;
an insulator coupled to the mounting part and having an aperture for allowing the threaded fastener to pass therethrough; and
a handle coupled to the insulator and having an aperture for allowing the threaded fastener to pass therethrough;
wherein the handle is fixedly secured to the mounting part, with the insulator fixedly held between the handle and the mounting part, when the threaded fastener is secured into the threaded aperture through the aperture on the insulator and the aperture on the handle.

2. The article of cookware of claim 1, wherein the cooking body is formed from aluminum.

3. The article of cookware of claim 1, wherein the mounting part is formed from aluminum.

4. The article of cookware of claim 1, wherein the handle is formed from aluminum.

5. The article of cookware of claim 1, wherein the insulator is formed from a plastic material.

6. An article of cookware, comprising:
a cooking body;
a mounting part coupled to the cooking body and including a threaded stud for receiving a threaded nut;
an insulator coupled to the mounting part and having an aperture for allowing the threaded stud to pass therethrough; and
a handle coupled to the insulator and having an aperture for allowing the threaded stud to pass therethrough;
wherein the handle is fixedly secured to the mounting part, with the insulator fixedly held between the handle and the mounting part, when the threaded nut is secured into the threaded stud after the threaded stud passes through the aperture on the insulator and the aperture on the handle.

7. The article of cookware of claim 6, wherein the cooking body is formed from aluminum.

8. The article of cookware of claim 6, wherein the mounting part is formed from aluminum.

9. The article of cookware of claim 6, wherein the handle is formed from aluminum.

10. The article of cookware of claim 6, wherein the insulator is formed from a plastic material.
